(19) United States
(12) Patent Application Publication
(10) Pub. No.: US 2026/0171272 A1
(43) Pub. Date: Jun. 18, 2026

(54) Spin-Polarized Whispering Gallery Mode Fusion with Anisotropic Particle Emission

(71) Applicant: János Dobos, Pécs (HU)

(72) Inventor: János Dobos, Pécs (HU)

(21) Appl. No.: 18/979,709

(22) Filed: Dec. 13, 2024

(51) Int. Cl. G21B 3/00

(52) U.S. Cl. CPC G21B 3/008

(57) ABSTRACT

The invention introduces a technology that enhances the efficiency of fusion reactions by utilizing whispering gallery mode polarized laser beams to generate a magnetic field stronger than 100 Tesla, plasma meeting fusion criteria, and polarized deuteron, tritium, and helium-3 ions within the plasma. Whispering gallery mode polarization increases the fusion reaction cross-section, thereby reducing the energy input required for fusion and fast ignition conditions. Furthermore, it enables the directional control of reaction products, including neutrons, alpha particles, and protons. The magnetic field exceeding 100 Tesla, generated by the whispering gallery mode polarized laser beams, also protects the polarized plasma from depolarization effects.

### FIELD OF THE INVENTION

Nuclear fusion, more specifically spin-polarized whispering gallery mode nuclear fusion.

### BACKGROUND

According to the current state of science, the use of polarized fusion fuel represents a promising advancement toward achieving nuclear fusion.

The photon plays a significant role in all polarization methods. In spin polarization achieved through optical pumping, photons directly create resonance transitions between electrons or nuclei. The spin and polarization of the photons are transferred to the electrons, and through the interactions between electrons and nuclei, the nuclei's spins are polarized. In dynamic nuclear polarization, which includes the case of magnetic resonance polarization, the process seemingly occurs through the spin-spin interaction between electrons and nuclei; however, the initial electron spin polarization is created by microwave photons. The photons of microwave radiation excite spin transitions at the electron level, which subsequently mediate polarization to the nuclei. In orientation using a magnetic field, the magnetic field can also be interpreted through virtual photons. The influence of the magnetic field stabilizes or aligns the spin states of the particles in a preferred direction. Polarization of atomic beams using polar methods is also generally enhanced by laser photons tuned precisely to the resonance frequency of the atom. Here too, photons mediate the spin transition. In metastable optical pumping, atoms are specifically excited into a metastable state using photons, where their spins are polarized. The energy and polarization of photons directly affect the nuclei.

The polarization of photons originates from the properties of electromagnetic waves, as the photon is the quantum of the electromagnetic field. Polarization describes the oscillation direction of the electric and magnetic fields of the photon relative to the direction of wave propagation. The types of photon polarization include linear polarization, where the electric field oscillates in a fixed direction perpendicular to the propagation direction; circular polarization, where the electric and magnetic fields rotate along the propagation direction while maintaining constant amplitude (the rotation can be either right-hand circular or left-hand circular); and elliptical polarization.

For the reasons outlined above, in the present invention, polarization by polarized photon radiation encompasses all methods where polarized photons aid the polarization of fusion fuels.

According to the main findings of the 2024 study titled “Polarized Fusion and Potential In Situ Tests of Fuel Polarization Survival in a Tokamak Plasma,” aligning the spins of deuterium (D) and tritium (T) nuclei can increase the fusion reaction cross-section by up to 1.5 times. A disadvantage of the invention is that it separates the polarization of fusion fuels from the fusion process, thus necessitating the storage of the polarized fusion fuel.

Patent WO2024132296 describes a method and apparatus for producing polarized atoms, molecules, or ions. The innovation is based on an oscillating magnetic field that polarizes the spin states of atoms or molecules. The core of the method involves directing atomic beams through adiabatic transitions in a weak, time-varying magnetic field while stabilizing and aligning spin states with a high-frequency electromagnetic field (e.g., 2900 MHz). A drawback of the invention is that it separates the polarization process from the fusion reaction, necessitating the storage of polarized fusion fuel.

In the article titled “The Benefits of Spin Polarization for Inertial and Magneto-Inertial Fusion Propulsion” by Gerrit Bruhaug from the University of Rochester Laboratory, it is highlighted that spin polarization increases the anisotropy of fusion product emissions. As a result, spin-polarized fusion offers the potential to reduce the thickness of neutron shields for interstellar spacecraft.

Studies agree that the primary challenges include: first, how to produce enough polarized fuel to sustain continuous fusion reactions; second, how to store the volatile, small-sized, and highly permeable polarized fusion materials; and third, whether the polarization can be maintained under the extreme depolarization conditions of fusion plasma. These depolarization conditions include plasma turbulence, high-amplitude Larmor gyro-motion, particle collisions that suppress spin polarization, magnetic field inhomogeneities, and high temperatures, which lead to extremely rapid particle motion that can cause the loss of spin polarization.

### SUMMARY OF THE INVENTION

During experiments related to the inventor's pending patents-such as US 2024/0347219 A1, U.S. Ser. No. 18/240,362, U.S. Ser. No. 18/397,126, US 2023/0306253 A1, and U.S. Ser. No. 18/759,898—the inventor discovered that using a polarized laser operating in a single mode significantly increases fusion cross-sections.

By employing whispering gallery mode polarized lasers, the inventor introduces an innovative, previously unknown, and non-obvious solution to the challenges mentioned earlier. This invention enables the creation of a magnetic field exceeding 100 Tesla and the formation of fusion-criteria plasma containing polarized deuteron, tritium, and helium-3 ions. The whispering gallery mode polarization enhances fusion reaction cross-sections, reducing the energy input required for fusion and fast ignition conditions. Furthermore, it allows controlled directionality of reaction products, such as neutrons, alpha particles, and protons.

Since the invention directly polarizes the deuterons of the fusion fuel immediately before fusion and extends the polarization to the new reaction products, tritium, and helium-3 ions, it clearly overcomes several challenges. It ensures the production of sufficient polarized fuel to sustain continuous fusion reactions, eliminates the need to separately manufacture and store polarized fusion materials, and maintains polarization under the extreme depolarization conditions of fusion plasma due to the high-strength magnetic field.

The invention is best understood through the accompanying drawings.

### BRIEF DESCRIPTION OF THE DRAWINGS

FIG. 1.A. Schematic illustration of random particle polarization according to the invention.

FIG. 1.B. Schematic illustration of particle polarization aligned along a magnetic field according.

FIG. 2. Schematic illustration showing how the toroidal magnetic moment closely associated with the spin of polarized particles aligned along the external magnetic field facilitates fusion.

FIG. 3. Schematic illustration showing isotropic neutron emission for unpolarized and anisotropic emission for polarized deuterium-tritium fusion.

FIG. 4. Schematic illustration showing isotropic alpha particle and proton emission for unpolarized and anisotropic emission for polarized deuterium-helium-3 fusion.

FIG. 5.A. Schematic illustration of an embodiment of the invention featuring a half-snail target.

FIG. 5.B. Schematic illustration of an embodiment of the invention featuring eight half-snail targets.

FIG. 6. Schematic illustration of an embodiment of the invention featuring a spherical capsule operating on whispering gallery mode magnetic inertial principles.

### DETAILED DESCRIPTION OF INVENTION

In this description, we present embodiments of the invention titled spin-polarized whispering gallery mode fusion with anisotropic particle emission. Our goal is twofold: first, to demonstrate how deuterium, tritium, and helium-3 ions can be technically polarized directly before the fusion reaction, and second, to illustrate how anisotropic emission can be achieved following the fusion process.

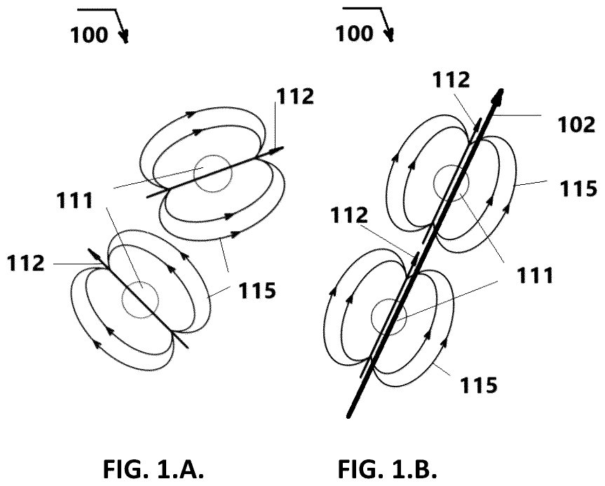

FIG. 1.A. is a schematic diagram showing an embodiment of the invention 100 spin-polarized whispering gallery mode fusion with anisotropic particle emission, where 111 particle polarization is random. Therefore, the directions of the 112 spins of 111 particles with 115 toroidal magnetic moments are randomly distributed, representing the typical state unaffected by external influences.

FIG. 1.B. is a schematic diagram showing an embodiment of the invention 100 spin-polarized whispering gallery mode fusion with anisotropic particle emission, where 111 particle polarization is aligned along a 102 magnetic field. Consequently, the 112 spins of 111 particles with 115 toroidal magnetic moments align parallel to the direction of the 102 magnetic field under the influence of the strong external field as described in the invention.

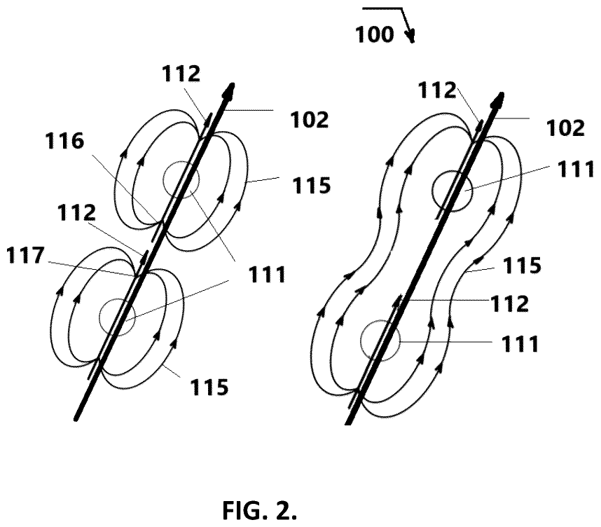

FIG. 2. is a schematic diagram demonstrating how the 115 toroidal magnetic moment associated with the 112 spins of polarized 111 particles aligned along the strong external 102 magnetic field facilitates their fusion. The magnetic field of the 115 toroidal magnetic moment creates a 116 suction branch and a 117 pressure branch. It is evident that the parallel orientation of the toroidal magnetic moments of polarized 111 particles, enabled by the aligned 112 spins, promotes magnetic attraction between the particles and the connection of their 115 toroidal magnetic moments as shown in the figure. The effect of the 116 suction branch and 117 pressure branch can reduce the Coulomb barrier, which is particularly significant for fusion.

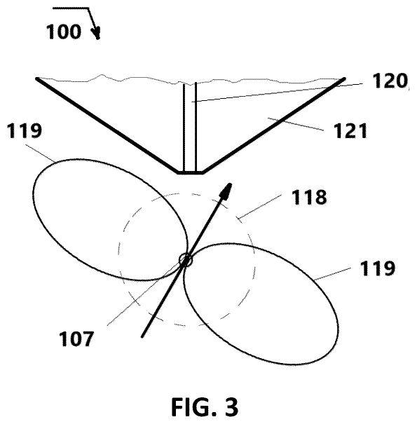

FIG. 3. is a schematic diagram showing how 107 neutron emission can be directed in the invention 100 spin-polarized whispering gallery mode fusion with anisotropic particle emission, for example, in deuterium-tritium fusion. According to current knowledge, the emission of 107 neutrons in unpolarized fuel is isotropic, as indicated by the dashed circle in the figure showing 118 isotropic emission. However, in the solution provided by the invention, the emission of 107 neutrons in spin-polarized fuel becomes directional, as indicated by the ellipses in the figure, with 119 anisotropic emission perpendicular to the spin. This is due to quantum mechanical conservation of momentum, energy, and spin correlation, which favor the direction perpendicular to the spin. Through 119 anisotropic emission, harmful 107 neutron radiation can be technically shielded from structural elements of fusion reactors, such as 120 fusion fuel feeders or 121 spacecraft propulsion systems.

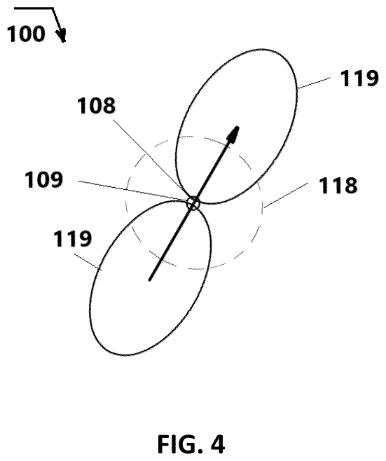

FIG. 4. is a schematic drawing showing how the emission of 108 alpha particles and 109 proton radiation can be directed in the invention 100 spin-polarized whispering gallery mode fusion with anisotropic particle emission, for example, in deuteron-helium-3 fusion. In unpolarized fusion fuel, 108 alpha particles and 109 protons exhibit 118 isotropic emission, meaning the particles are evenly distributed in all directions due to random spin states. In contrast, 108 alpha particles and 109 protons from polarized fusion fuel exhibit 119 anisotropic emission, meaning the emitted particles primarily propagate forward and backward along the spin axis. This phenomenon results from the observed effects of particle polarization, momentum and energy conservation, and spin correlation rules. Through 119 anisotropic emission, the charged 108 alpha particles and 109 protons can be directed using magnetic fields, simplifying their energetic utilization or increasing thrust in fusion-powered spacecraft.

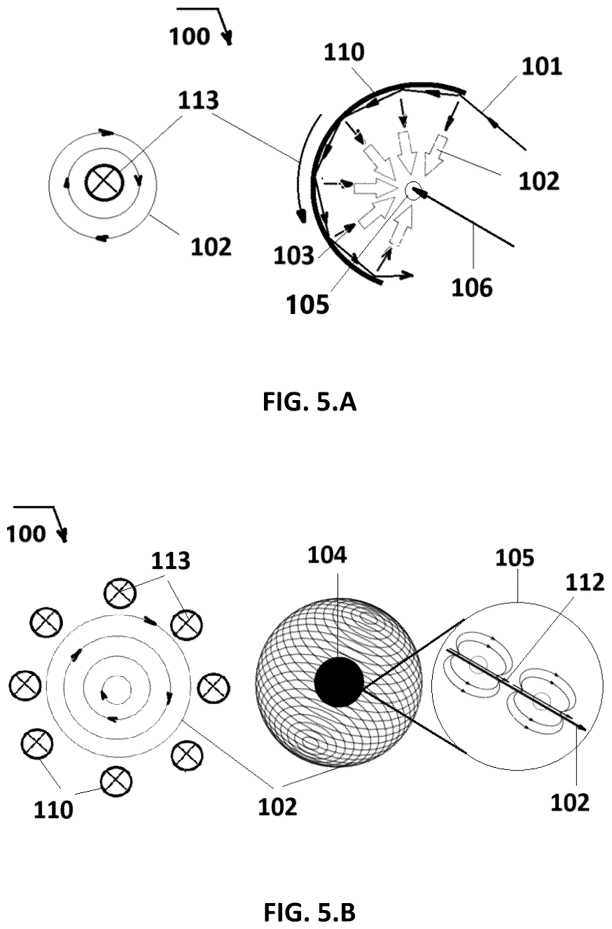

FIG. 5.A. is a schematic drawing showing an embodiment of the invention 100 spin-polarized whispering gallery mode fusion with anisotropic particle emission, where a 101 whispering gallery mode polarized photon beam is fired at the upper part of a 110 half-snail target. The beam propagates in whispering gallery mode along the 110 half-snail target. The heated electrons in the 110 half-snail target transfer their energy to cooler particles, inducing strong 113 spin currents that generate a strong 102 magnetic field and 103 secondary radiation exploding toward the cold center. This solution can be supplemented with a 106 polarized fast ignition photon beam, which enhances pre-fusion polarization. Therefore, the generation of 105 spin-polarized deuterium, tritium, and helium-3 ions was facilitated by the 101 whispering gallery mode polarized photon beams, the 102 magnetic field generated by the 101 whispering gallery mode polarized photon beams 103 the secondary radiation generated by the 101 whispering gallery mode polarized photon beams and 106 polarized fast ignition photon beam.

FIG. 5.B. is a schematic drawing showing an embodiment of the invention 100 spin-polarized whispering gallery mode fusion with anisotropic particle emission, where eight 110 half-snail targets are arranged in a spherical configuration. Eight 101 whispering gallery mode polarized photon beams are fired at the upper parts of the eight 110 half-snail targets, propagating in whispering gallery mode along them. The heated electrons in the 110 half-snails target transfer their energy to cooler particles, inducing strong 113 spin currents that generate a spherical, interconnected strong 102 magnetic field. The strong spherical 102 magnetic field creates 104 compressed plasma, in which 105 spin-polarized deuterium, tritium, and helium-3 ions are generated along the direction of the 102 magnetic field. The 112 spin orientation continues to align with the lines of the 102 magnetic field and becomes increasingly concentrated toward the center. Due to the circular pattern of the resulting 102 magnetic field, the spins of 105 spin-polarized deuterium, tritium, and helium-3 ions continuously adjust to the local direction of the 102 magnetic field. This dynamic process causes the 112 spins to precess around the magnetic field (Larmor precession). However, because the 105 spin-polarized deuterium, tritium, and helium-3 ions undergo this process collectively, the fusion cross-section increases. Despite extreme conditions (high temperature, collisions), the spherical 102 magnetic field can maintain spin polarization, reducing the Coulomb barrier and facilitating particle interactions.

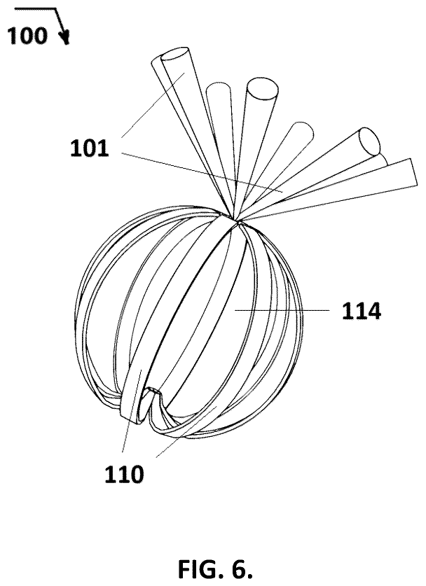

FIG. 6. is a 3D schematic drawing of an embodiment of the invention 100 spin-polarized whispering gallery mode fusion with anisotropic particle emission. The capsule is a 114 spherical whispering gallery mode magnetic inertial capsule made of quartz glass, 3 mm in diameter with a wall thickness of 300 micrometers. Eight 110 half-snail targets, each made of 30-micron thick, 200-micron wide copper sheets, are attached at equal distances along the inner wall. The capsule is pressurized with 1 mg of deuterium. A total of 8×100=800 joules of p-polarized laser energy, forming 101 whispering gallery mode polarized photon beams, is fired at the upper parts of the 110 half-snail targets, propagating in whispering gallery mode along them. The experiment generates a spherical magnetic field with a strength of 250 Tesla, a temperature of 1.5 billion degrees Celsius, and high particle density for 25 ns, meeting the Lawson criteria for the following fusion reactions.

| Fusion Reaction | Lawson- Criterion | Temperature | Temperature | Density for10 ns |
|---|---|---|---|---|
| Deuterium-Trícium (D-T) | nτ ≥ 10\hat{ }14 s/cm3 | 13 keV | 150 millió ° C. | 10\hat{ }22/ cm3 |
| Deuterium-Deuterium (D-D) | nτ ≥ 10\hat{ }16 s/cm3 | 40 keV | 460 millió ° C. | 10\hat{ }24/ cm3 |
| Deuterium-Helium3 (D-He3) | nτ ≥ 10\hat{ }16 s/cm3 | 58 keV | 670 millió ° C. | 10\hat{ }24 /cm3 |

The eight 8×100=800 Joule p-polarized laser beams—101 whispering gallery mode polarized photon beams—with their exceptionally low energy, were sufficient to achieve fusion and meet the Lawson criteria because they polarized and aligned the spins of deuterium, tritium, and helium-3 ions in the plasma. This alignment increased the fusion cross-section, thereby enhancing the likelihood of fusion. We started from the following basic spin data for spin alignment.

| | Number of | Number of | | |
|---|---|---|---|---|
| Ion | Protons | Neutrons | Spin | Reason |
| Deuteron | 1 | 1 | 1 | The proton and neutron spins are parallel, so S = 1. |
| Trícium | 1 | 2 | ½ | The spins of the two neutrons are opposite, leaving |
| | | | | the spin as the proton's spin. |
| Hélium-3 | 2 | 1 | ½ | The spins of the two protons are opposite, leaving |
| | | | | the spin as the neutron's spin. |

To measure the efficiency of spin polarization, we compared the results of experiments conducted with polarized and non-polarized deuterium fuels. The comparison revealed the following efficiency increases:

| | | Whispering Gallery | |
|---|---|---|---|
| | Non-Polarized | Mode Polarized | |
| Metric | Photon Beams | Photon Beams | Efficiency |
| Laser Energy Output | 800 J | 800 J | — |
| Magnetic Field | 100 Tesla | 250 Tesla | 2.5 times higher |
| Particle Density | 10\hat{ }22/cm3 | 10\hat{ }24/cm3 | 100 times higher |
| Temperature | 150 million ° C. | 1.5 billion ° C. | 10 times higher |

The above integrates whispering gallery mode and optical pumping to create spin polarization and a magnetic field. By combining polarized lasers with low-energy fusion solutions, this approach paves the way for more efficient and cost-effective realization of fusion energy.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. Spin-polarized whispering gallery mode fusion with anisotropic particle emission (100), characterized by comprising:
whispering gallery mode polarized photon beams (101),
a magnetic field (102) generated by whispering gallery mode polarized photon beams (101),
secondary radiation (103) generated by whispering gallery mode polarized photon beams (101),
compressed plasma (104) generated by the magnetic field (102) generated by whispering gallery mode polarized photon beams (101), secondary radiation (103) generated by whispering gallery mode polarized photon beams (101),
spin-polarized deuterium, tritium, and helium-3 ions (105), generated by whispering gallery mode polarized photon beams (101), the magnetic field (102) generated by whispering gallery mode polarized photon beams (101), secondary radiation (103) generated by whispering gallery mode polarized photon beams (101), and polarized fast ignition photon beams (106),
anisotropic emission (119) of neutrons (107), alpha particles (108), and protons (109).
